(19) United States
(12) Patent Application Publication
(10) Pub. No.: US 2025/0046217 A1
(43) Pub. Date: Feb. 6, 2025

(54) SIGNAGE PLACARD

(71) Applicant: Derek T. Versteegen, Rolesville, NC (US)

(72) Inventor: Derek T. Versteegen, Rolesville, NC (US)

(21) Appl. No.: 18/718,681

(22) PCT Filed: Feb. 11, 2023
(86) PCT No.: PCT/US23/12863

§ 371 Date: Jun. 11, 2024

Related U.S. Application Data
(60) Provisional application No. 63/288,551, filed on Dec. 11, 2021.

(51) Int. Cl. G09F 1/04; G09F 13/00

(52) U.S. Cl. CPC G09F 1/04; G09F 13/00

(57) ABSTRACT

A signage placard having a backing member and at least one display member not substantially perpendicular or parallel to the backing member. At least one display member extends from the backing member at a shared edge. A display member may share an edge with another display member extending therefrom. The placard may be used to display content and is typically affixed to any viewable surface, including behind existing signage such that the placard does not cover or obstruct otherwise viewable aspects of the existing signage. The placard may have apertures to facilitate alignment and fastening as well as to reduce overall weight and quantity of materials used to manufacture the placard. The placard may be manufactured using a variety of materials and may have an illumination system.

### CROSS-REFERENCE TO RELATED APPLICATIONS

This application claims the benefit of Provisional Application No. 63/288,551, filed Dec. 11, 2021, the disclosures of which are incorporated herein by reference.

### TECHNICAL FIELD OF THE INVENTION

The present disclosure relates generally to a placard, and more specifically, a placard that is typically used to enhance existing signage with additional content.

### BACKGROUND

Signage is often used on the surfaces of buildings, vehicles, mailbox posts, houses, and interior walls, including, for example, a license plate on a car, a conference room name plate on a wall, or an address plaque on the outside of a home or mailbox.

Adding content to signage often requires fitting frames, stickers, displays, and combinations thereof over signage. These methods can obscure existing signage, inhibit a user's ability to exchange content, limit viewing angles, and require multiple components, including additional fasteners.

No satisfactory solution has been developed to easily customize and enhance signage with additional content using a lightweight and customizable placard that is cost-effective, minimizes the risk of breakage or malfunction, and improves the visibility of additional content.

### BRIEF SUMMARY OF THE INVENTION

The present invention relates to a placard typically made from a single piece of rigid or semi-rigid material that provides a user with a versatile, durable, and affordable new way to display and exchange content. The placard is typically paired with and placed behind existing signage, such that the placard does not cover or obstruct otherwise viewable aspects of existing signage. The placard may also be used to display content without being paired with existing signage. The placard reduces the cost and effort associated with affixing a display to a surface and increases the area on which content may be displayed.

The present invention may be affixed to various surfaces, for example, one or any combination of a vehicle, building, sidewalk, road, wall, window, and any other surface that might be enhanced with content. The placard may also include illumination for further customization and improved visibility. The placard can create and increase advertising space in highly visible locations and locations already used to attract a viewer's attention, for example, when paired with existing signage. Content may be displayed at optimum and customized angles for enhanced visibility and can be quickly, easily, and cost-effectively interchanged using multiple variations of the invention.

Additional features and advantages of the invention will be set forth in the description which follows, and in part will be obvious from the description, or may be learned by the practice of the invention. The invention is not limited in its application to the details of construction and to the arrangements of the components set forth in the following description or illustrated in the drawings.

### BRIEF DESCRIPTION OF THE DRAWINGS

FIG. 1 is a perspective view of an embodiment of the placard.

FIGS. 2A-C illustrate top views of non-rectangular exemplary embodiments of the display member of FIG. 1.

FIG. 3 is an isometric view of an embodiment of the placard.

FIGS. 4A-C illustrate exemplary embodiments of the placard comprising multiple display members.

FIGS. 5A-F illustrate side views of exemplary embodiments of the placard.

FIGS. 6A-C illustrate exemplary embodiments of the placard comprising noncontinuous members.

FIGS. 7A-D illustrate exemplary embodiments of the placard of FIG. 6C having custom content.

FIG. 8 illustrates a block diagram of an illumination system used with an embodiment of the placard.

FIGS. 9A-D illustrate exemplary embodiments of the placard used in different environments.

### DETAILED DESCRIPTION OF THE INVENTION

Exemplary embodiments of the present invention are directed toward a placard comprising a backing member and one or more display members. The backing member and display members each comprise a substantially thin body of material having one or more edges that define a shape. An edge can be characterized by material thickness, a bend in material, a joint, and any combination thereof. The backing member shares an edge with at least one display member and at least one display member is not substantially perpendicular or parallel to the backing member. A display member can share an edge with another display member. A display member can extend from a shared edge for the entire length of, a portion of the length of, or beyond the length of any shared edge.

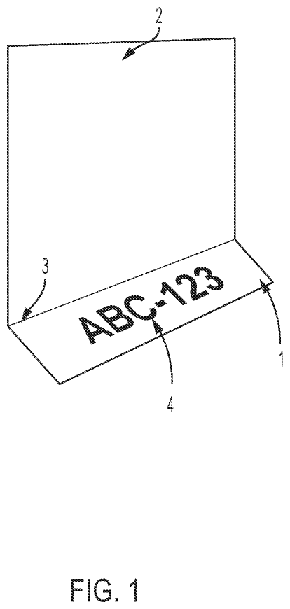

FIG. 1 illustrates a perspective view of an embodiment of the placard comprising a substantially planar display member 1 extending from a substantially planar backing member 2 at a shared edge 3. The display member 2 is not perpendicular or parallel to backing member 1 and is otherwise angled to optimize the visibility of content 4 when the placard is affixed to its desired location. In another embodiment, the display member 1 is not substantially planar. In yet another embodiment, the backing member 2 is not substantially planar.

In the embodiment illustrated in FIG. 1, both the display member 1 and the backing member 2 are rectangular in shape, but the display member 1 and the backing member 2 can be any shape and size suitable for the purposes described herein. The shape and size of a backing member and a display member may depend on the shape and size of the placard and placard components, the materials used to form each of the backing member and display members, the types of content applied to the placard, the surfaces on which a placard is to be affixed, and any combination thereof. The angle of a display member relative to a backing member can be customized based on the display location of the placard with respect to the location of typical viewers.

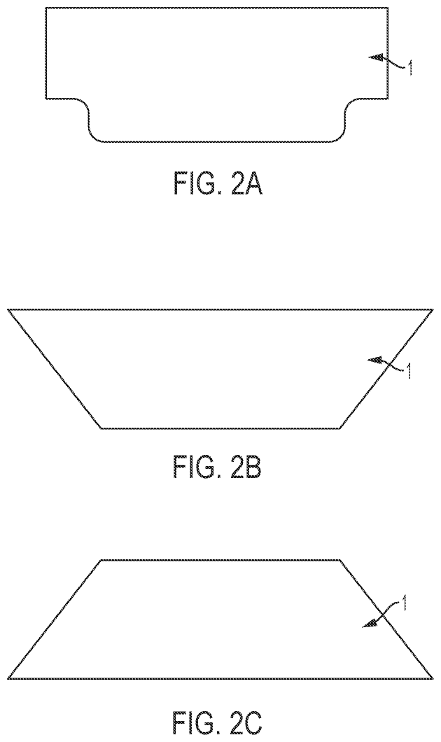

FIGS. 2A-C each illustrate a top view of an exemplary embodiment of a display member 2 comprising a non-rectangular shape.

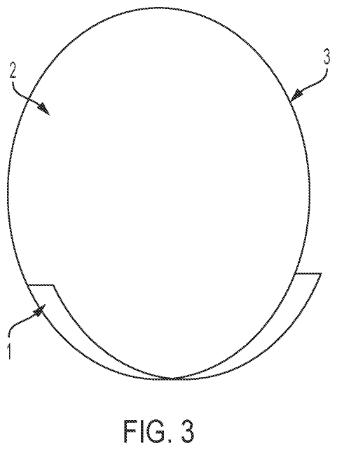

FIG. 3 illustrates an exemplary embodiment of the placard comprising a curved display member 1 extending from a disk-shaped backing member 2 at a shared edge 3.

Alternative embodiments of the placard have more than one display member. For example, multiple display members can extend directly from the backing member at one or more shared edges. Display members can also extend from other display members.

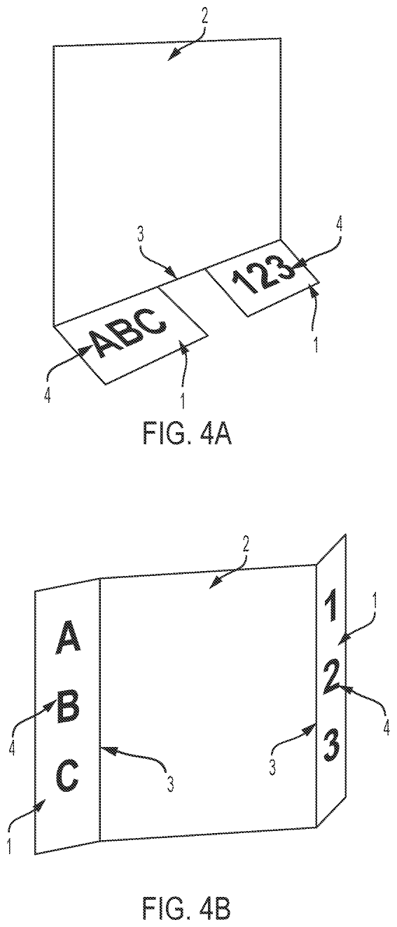

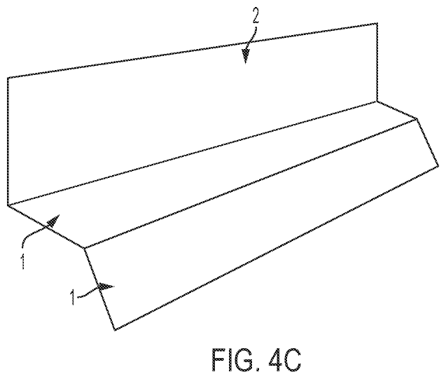

FIGS. 4A-C illustrate various embodiments of the placard having multiple display members 1. FIG. 4A illustrates a perspective view of an exemplary embodiment of the placard comprising multiple display members 1, each extending from a backing member 2 at a shared edge 3. In this embodiment, each display member 1 extends from the backing member 2 along a portion of the length of the shared edge 3. Display members 1 are not perpendicular or parallel to the backing member 2 and are otherwise angled to optimize visibility of content 4 when the placard is affixed to its desired location. FIG. 4B illustrates an exemplary embodiment of the placard comprising multiple display members 1 extending from a backing member 2 at various shared edges 3. In this embodiment, each display member 1 extends from the backing member 2 along the entire length of a respective shared edge 3. Display members 1 are not perpendicular or parallel to the backing member 2 and are otherwise angled to optimize visibility of content 4 when the placard is affixed to its desired location. FIG. 4C illustrates the placard of FIG. 1 comprising a display member 1a extending from display member 1. Display member 1 extends from backing member 2. Display member 1 and display member 1a are not perpendicular or parallel to the backing member 2 and are otherwise angled to optimize visibility of content 4 when the placard is affixed to its desired location. In another embodiment of FIG. 4C, only display member 1 or 1a is not perpendicular or parallel to the backing member 2.

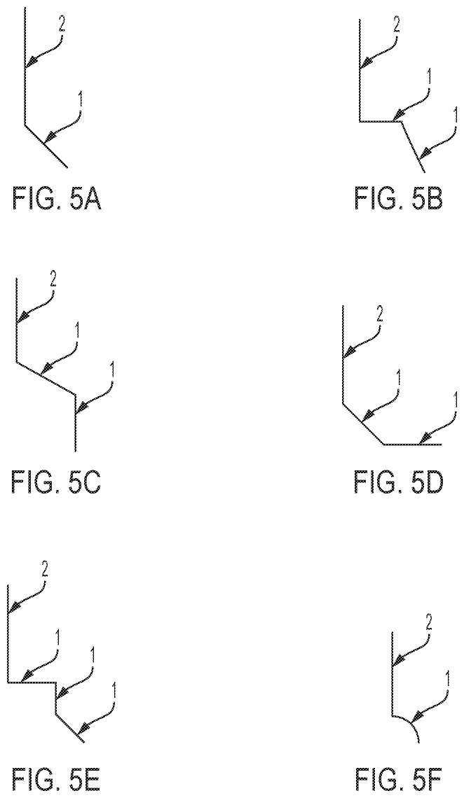

FIGS. 5A-E illustrate side views of examples of various embodiments of the placard comprising at least one display member 1 that is not perpendicular or parallel to the backing member 2. It should be noted that FIGS. 5A-E do not provide exhaustive examples of the configurations of the placard and any of its components, angles at which display members may extend from a backing member, or direction from which the placard should be viewed.

In the preferred embodiment, the backing member and the display member of the placard are manufactured from a single piece of material to reduce manufacturing costs and increase durability. In another embodiment, the backing member and the display member are manufactured from separate pieces of material and can enable further customizability of the placard. The display members and backing member of a placard can be manufactured using the same or different materials, respectively, and can be manufactured using materials that are rigid, semi-rigid, magnetic, adhesive, reflective, photovoltaic, and any combination thereof.

Materials used to manufacture the placard can include, without limitation, metals, metallic materials, alloys, polymers, ceramics, wood, elastic polymeric substances, grasses, glass, textiles, composite materials, and any combination thereof. The overall size and shape, materials used, and continuity of the backing member and display member can depend on the type, size, and weight of signage; additional content to be paired with the placard; the material of the placard; environmental considerations; and surface to which the placard is affixed.

The members of the placard can be continuous, noncontinuous, and a combination of both. Breaks in continuity of the placard members can facilitate reduction of the overall weight of the placard and material consumption during manufacturing. Breaks in member continuity can be located within the placard in a manner and quantity that maintains the integrity and overall strength of the placard while providing increased versatility, especially when used with fasteners.

Fasteners may be used to affix embodiments of the placard to surfaces, for example, buildings, walls, vehicles, windows, signage, additional content, and any combination thereof. Fasteners can include mechanical fasteners such as, but not limited to, screws, nails, bolts, suction cups, velcro, and dowels. Fasteners can also include forces such as, without limitation, adhesive, magnetic, and electromagnetic forces. The placard may be affixed to a surface using mechanical fasteners, fastening forces, and a combination of both. The backing member of the placard can function as a fastener.

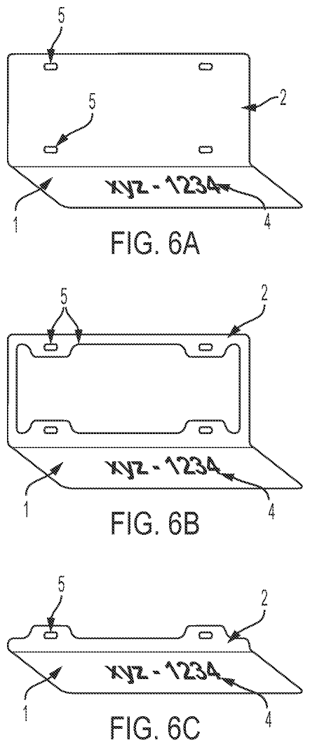

FIGS. 6A-C illustrate various embodiments of the placard having configurations of the backing member 2 that are noncontinuous. FIG. 6A illustrates an embodiment of the placard comprising a backing member 2 that is noncontinuous and generally planar with four apertures 5 that can be used to align and affix the placard to a surface using fasteners. Apertures 5 can be elongated slots sized to facilitate alignment of the backing member 2 with one or more surfaces. FIG. 6B illustrates an embodiment of the placard comprising backing member 2 having five apertures 5 that can be used to align and affix the placard to a surface using fasteners and to reduce the overall weight of backing member 1. FIG. 6C illustrates one embodiment of the placard comprising backing member 1 having two apertures 5.

Content can be printed on, affixed to, and integrated into any component of a placard at any time, to include during the manufacturing process and thereafter. For example, reflective materials used to comprise and enhance content may be applied during and after the manufacturing process.

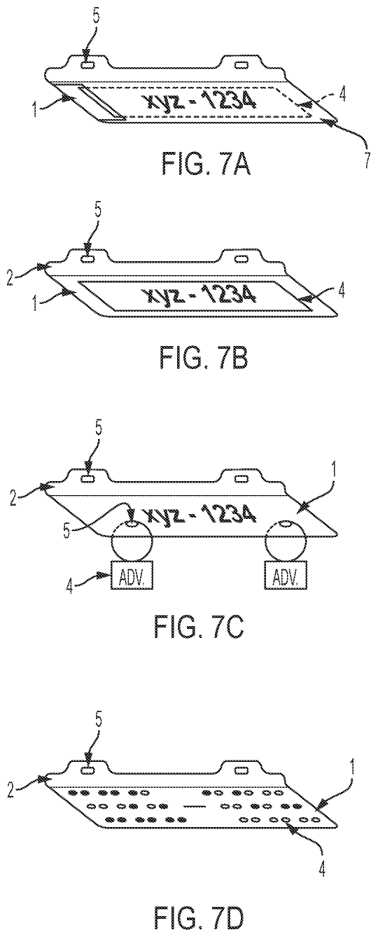

FIGS. 7A-D illustrate various embodiments of the placard of FIG. 6C with exemplary methods for displaying content. FIG. 7A illustrates a display member 1 with a sleeve 7 to insert signage and other content. FIG. 7B illustrates a display member 2 having content 4 affixed to the display member by force, for example, magnetic or adhesive forces. FIG. 7C illustrates a display member 1 with apertures 5 to facilitate affixing content 4 to the display member 1. FIG. 7D illustrates a display member 1 with embossed content 4, such as braille.

In alternative embodiments, content may be added to the placard through inlay, engraving, stamping, and any combination of methods described herein or else suitable for use with the present invention. Customized methods for displaying content illustrated in FIGS. 7A-D are shown as used with a display member of the present invention, but it should be understood that these methods may also be used with a backing member.

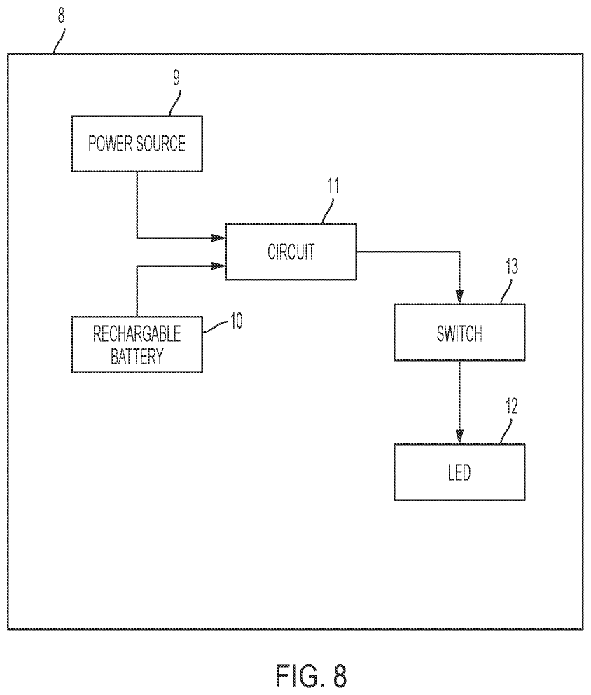

The placard may further comprise an illumination system. FIG. 8 illustrates a block diagram of an exemplary illumination system 8 wherein energy is collected from one or more external power sources 9 and directed to at least one rechargeable battery 10 by a circuit 11, which can also cause selective activation or deactivation of an LED 12 by a switch 13. In another embodiment of the illumination system, the system does not include a rechargeable battery. In yet another embodiment of the illumination system, the system does not include an external power source.

External power sources for an illumination system of the present invention may supply direct or alternating current, and components within the illumination system may further include one or more power converters. External power sources can include commercial power grids, batteries, solar cells, any other suitable power source, and any combination thereof. Components of the illumination system may be located in the backing member, one or more display members, outside of the placard, and any combination thereof.

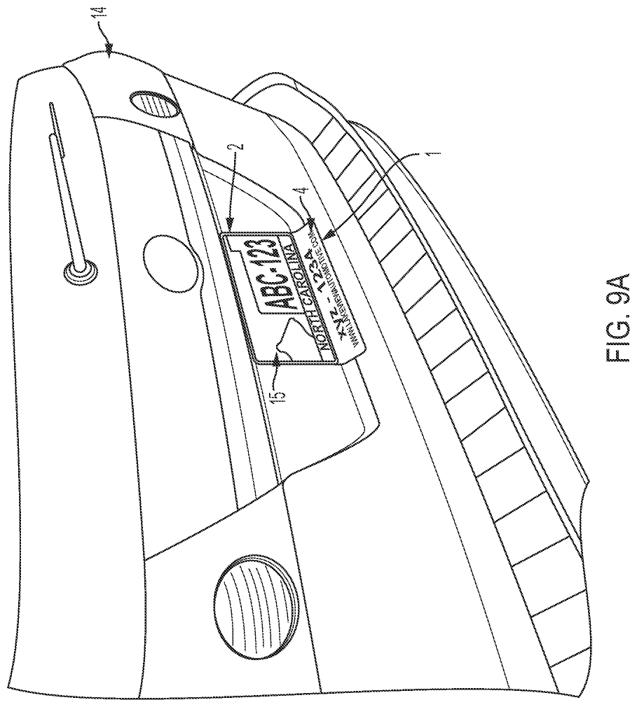

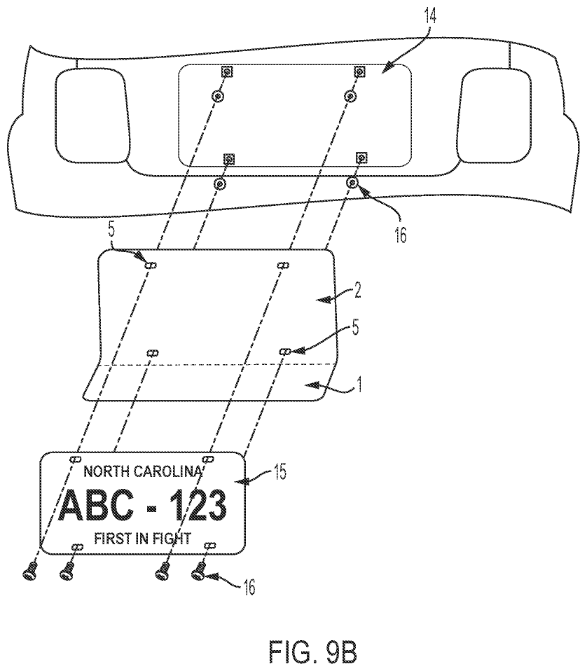

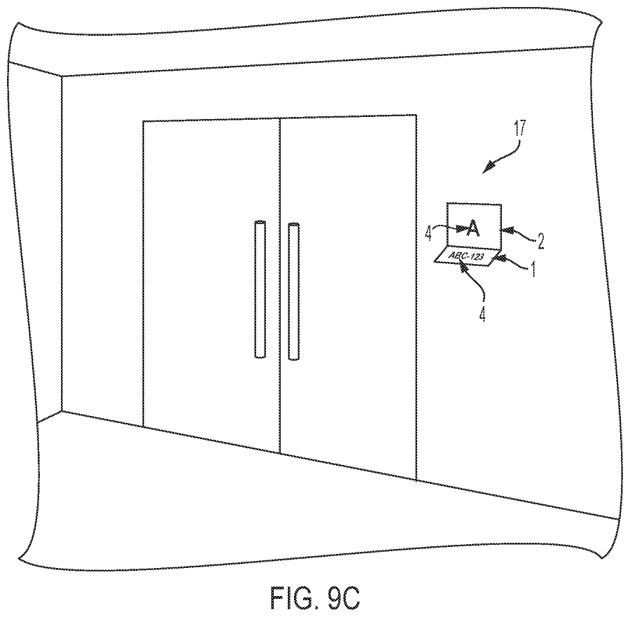

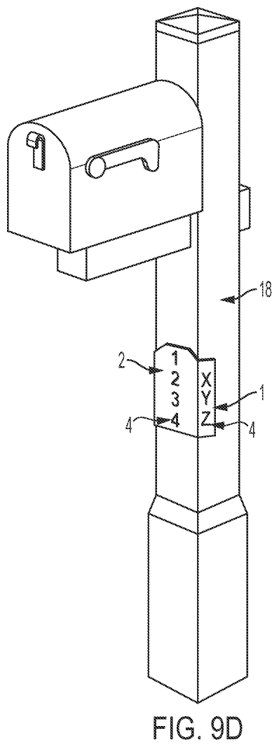

FIGS. 9A-D illustrate various embodiments of the placard used in different environments. A display member is angled relative to a backing member to optimize content visibility, reduce content distortion, and expand the range of content visibility based on the display location of the placard with respect to the location of typical viewers. FIG. 9A illustrates an embodiment of the placard where backing member 2 of the placard is affixed to an automobile 14 behind a license plate 15, and content 4 is visible on display member 1. FIG. 9B illustrates an exploded view of the method used to affix the placard of FIG. 9A to automobile 14 using fasteners 16 threaded through apertures 5 to facilitate the alignment of the license plate 15 to the backing member 2 and the backing member 2 to the automobile 14. FIG. 9C illustrates an embodiment of the placard affixed to a wall 17, such as that defining a conference room, with content 4 displayed on both a backing member 2 and a display member 1. FIG. 9D illustrates an embodiment of the placard affixed to a post 18, such as that supporting a mailbox, with content 4 displayed on the backing member 2 and the display member 1.

1: A placard comprising:
more than one edge;
a backing member having at least one of said edges;
a display member having more than one of said edges;
wherein at least one of said edges is shared by the backing member and the display member;
wherein the display member is not substantially perpendicular or parallel to the backing member.

2: The placard as in claim 1 further comprising an illumination system.

3: The placard as in claim 1 further comprising apertures.

4: The placard as in claim 1 wherein the display member extends from the backing member at an angle that optimizes visibility of said display member when the placard is affixed to a surface.

5: The placard as in claim 1 wherein the backing member is continuous.

6: The placard as in claim 1 wherein the display member is continuous.

7: The placard as in claim 1 wherein the backing member is rigid.

8: The placard as in claim 1 wherein the display member is rigid.

9: The placard as in claim 1 wherein the backing member is planar.

10: The placard as in claim 1 wherein the display member is planar.

11: A placard comprising:
more than one edge;
a backing member having at least one of said edges;
more than one display member, wherein each of said display members has more than one of said edges;
wherein at least one of said edges is shared by the backing member and at least one of said display members;
wherein at least one of the display members is not substantially perpendicular or parallel to the backing member.

12: The placard as in claim 11 further comprising an illumination system.

13: The placard as in claim 11 further comprising apertures.

14: The placard as in claim 11 wherein the backing member is continuous.

15: The placard as in claim 11 wherein at least one of the display members is continuous.

16: The placard as in claim 11 wherein the backing member is rigid.

17: The placard as in claim 11 wherein at least one of the display members is rigid.

18: The placard as in claim 11 wherein the backing member is planar.

19: The placard as in claim 11 wherein at least one of the display members is planar.

20: The placard as in claim 11 wherein at least one of said edges is shared between display members.
